(19) United States
(12) Patent Application Publication
(10) Pub. No.: US 2026/0285487 A1
(43) Pub. Date: Sep. 24, 2026

(54) PASSENGER SEAT WITH ROTATABLE FRAME STRUCTURE

(71) Applicant: Safran Seats USA LLC, Gainesville, TX (US)

(72) Inventor: Ali Mohiti Asli, Frisco, TX (US)

(73) Assignee: Safran Seats USA LLC, Gainesville, TX (US)

(21) Appl. No.: 19/475,195

(22) PCT Filed: May 3, 2024
(86) PCT No.: PCT/US2024/027735

§ 371 Date: Oct. 14, 2025

(30) Foreign Application Priority Data
May 4, 2023 (WO) PCT/US2023/020967

(51) Int. Cl. B64D 11/06

(52) U.S. Cl. CPC B64D 11/0648

(57) ABSTRACT

Described are passenger seats for a passenger vehicle. The passenger seats may include a seat base that may include a frame structure. The frame structure may include a forward portion and an aft portion. The forward portion may include a forward aperture configured to receive a forward base frame tube. The aft portion may include an aft aperture configured to receive an aft base frame tube. The forward portion may be coupled to the aft portion such that the forward portion may be rotated relative to the aft portion.

### REFERENCE TO RELATED APPLICATION

This application claims foreign priority under 35 U.S.C. § 119 to International patent application PCT/US 2023/020967, filed on May 3, 2023, the content of which is hereby incorporated by reference in its entirety.

### FIELD OF THE INVENTION

The field of the invention relates to passenger seats for passenger vehicles, and, more particularly, to a passenger seat with a rotatable frame structure for passenger vehicles.

### BACKGROUND

Passenger vehicles, such as aircraft, buses, trains, ships, and automobiles, often include one or more passenger seats in which passengers may be seated and otherwise use during travel. A passenger seat may include a base frame that may allow a seating cushion of the passenger seat to be attached to the passenger seat. Traditionally, the base frame of the passenger seat has been monolithic. The monolithic base frames may not absorb or otherwise handle rotational stress adequately to be used in some passenger vehicles (e.g., aircraft). Additionally, the monolithic base frames may not provide an acceptable amount of stability or stress-absorption for use in passenger seats for passenger vehicles.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a passenger seat for an aircraft may include a seat base that may include a frame structure. The frame structure may include a forward portion and an aft portion. The forward portion may include a forward aperture configured to receive a forward base frame tube. The aft portion may include an aft aperture configured to receive an aft base frame tube. The forward portion may be coupled to the aft portion such that the forward portion may be rotated relative to the aft portion.

In some embodiments, the frame structure may be a spreader.

In certain embodiments, the frame structure may be a seat leg.

In some embodiments, the forward portion may be rotated in a lateral direction.

In certain embodiments, the forward portion may include an aft end, and the aft portion may include a forward end. Additionally, the forward end may be adjacent to the aft end, and at least one of the forward end or the aft end may include a stopper for limiting rotation of the forward portion relative to the aft portion.

In some embodiments, the stopper may be a first stopper of a pair of stoppers, and the forward end and the aft end may each include a different stopper of the pair of stoppers.

In certain embodiments, a structural bolt may rotatably couple the forward portion to the aft portion.

In some embodiments, a rotational axis of the forward portion may intersect at least one of the forward aperture or the aft aperture.

In certain embodiments, a rotational axis of the forward portion may not intersect the forward aperture or the aft aperture.

In some embodiments, the passenger seat may additionally include the forward base frame tube and the aft base frame tube.

In some embodiments, the frame structure may be a first frame structure, and the seat base may include a second frame structure. The second frame structure may include a forward portion and an aft portion. The forward portion may include a forward aperture configured to receive the forward base frame tube. The aft portion may include an aft aperture configured to receive the aft base frame tube. The forward portion of the second frame structure may be coupled to the aft portion of the second frame structure such that the forward portion of the second frame structure may be rotated relative to the aft portion of the second frame structure.

In various embodiments, the first frame structure may be a seat leg, and the second frame structure may be a spreader.

In various embodiments, an axis of rotation of the first frame structure may be at a non-zero angle relative to an axis of rotation of the second frame structure.

In certain embodiments, at least one of the first frame structure or the second frame structure may be a stopper for limiting rotation.

In some embodiments, the forward portion of the first frame structure and the forward portion of the second frame structure may be rotated together responsive to a dynamic event.

According to certain embodiments of the present invention, a spreader for a passenger seat for an aircraft may include a forward portion and an aft portion. The forward portion may include a forward aperture configured to receive a forward base frame tube. The aft portion may include an aft aperture configured to receive an aft base frame tube. The forward portion may be coupled to the aft portion such that the forward portion may be rotated relative to the aft portion.

In some embodiments, the forward portion may include a first stopper, and the aft portion may include a second stopper. The first stopper may be configured to engage the second stopper to limit rotation of the forward portion relative to the aft portion.

In certain embodiments, an axis of rotation of the forward portion may intersect at least the forward aperture.

According to certain embodiments of the present invention, a seat leg for a passenger seat for an aircraft may include a forward portion and an aft portion. The forward portion may be configured to be coupled to a floor of the aircraft. The aft portion may be configured to be coupled to the floor of the aircraft. The forward portion may be coupled to the aft portion such that the forward portion may be rotated relative to the aft portion.

In some embodiments, the forward portion may additionally include a forward aperture that may be configured to receive a forward base frame tube. The aft portion may additionally include an aft aperture that may be configured to receive an aft base frame tube.

### BRIEF DESCRIPTION OF THE DRAWINGS

FIG. 1 is a perspective view of a passenger seat with a rotatable frame structure according to certain embodiments of the present invention.

FIGS. 2A-C are views of a frame structure of the passenger seat of FIG. 1.

FIGS. 3A-C are views of the frame structure of FIGS. 2A-C.

FIGS. 4A-B are views of the frame structure of FIGS. 2A-C.

FIGS. 5A-C are views of another frame structure of the passenger seat of FIG. 1.

FIGS. 6A-B are front views of the frame structure of FIGS. 5A-C.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide passenger seats with rotatable frame structures for a passenger vehicle. While the passenger seats with rotatable frame structures are discussed for use with the passenger vehicle, they are by no means so limited. Rather, embodiments of the passenger seats with rotatable frame structures may be used in passenger vehicles of any type or otherwise as desired.

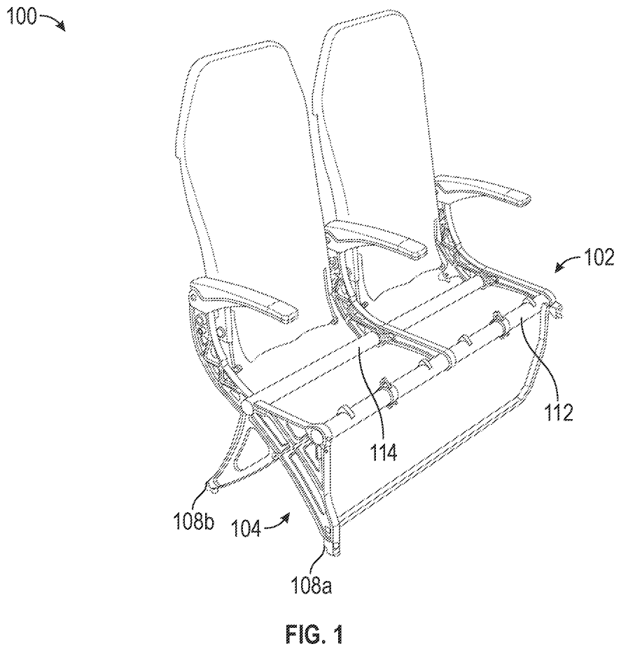

FIG. 1 is a perspective view of a passenger seat 100 according to certain embodiments of the present invention. The passenger seat 100 may be used on passenger vehicles, such as aircraft, trains, and the like, or at other suitable venues. In some embodiments, the passenger seat 100 may be configured to carry entities, such as individuals, etc., in a passenger vehicle, for example while the passenger vehicle is in motion or otherwise in use. The passenger seat 100 may experience various forces such as forces from roll, forces from pitch, forces from yaw, etc. In some embodiments, the passenger seat 100 may twist, lean, or otherwise at least temporarily displace from a resting state, and the passenger seat 100 may experience load, based on the forces received by the passenger seat 100.

The passenger seat 100 may include a seat base 102, which may include one or more frame structures 104. The one or more frame structures 104 may include, but are not limited to, spreaders, leg assemblies, and/or other frame structures as desired. The seat base 102 may include, or facilitate positioning, of a seat interface, seat pan, or other component for allowing a passenger to use the passenger seat 100. The passenger seat 100, for example via the seat base 102 or the frame structure 104, may be coupled to a base or floor of the passenger vehicle. For example, base joints 108a-b may be used to couple, such as mechanically, chemically, and the like, the passenger seat 100 to the floor of the passenger vehicle. Additionally, the passenger seat 100 may include a forward base frame tube 112 and an aft base frame tube 114.

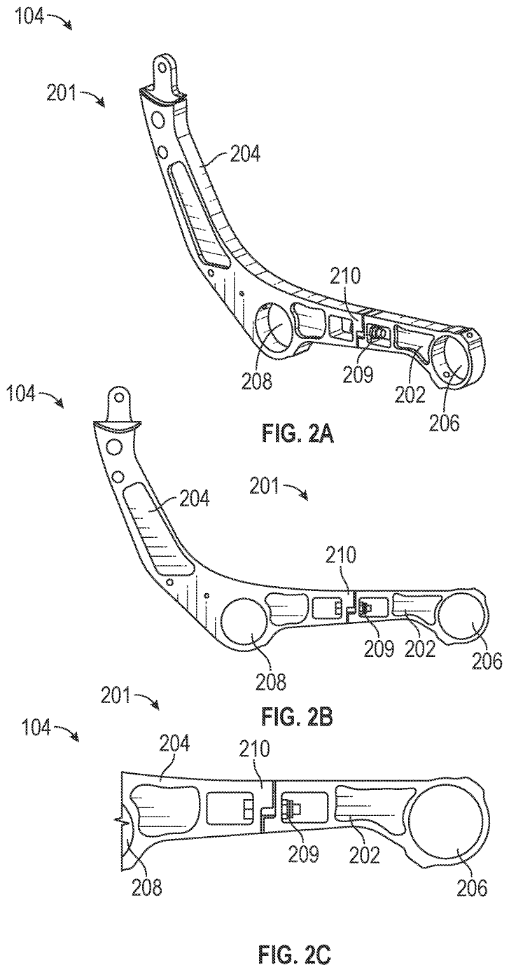

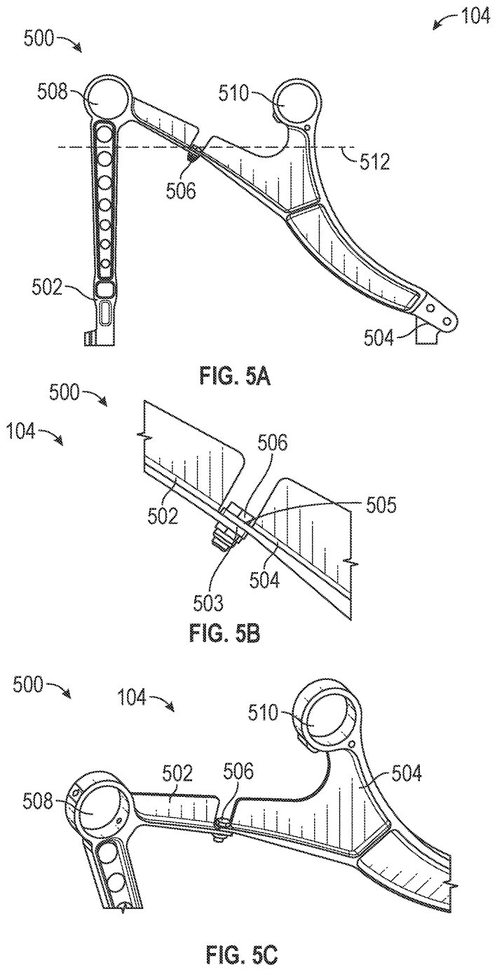

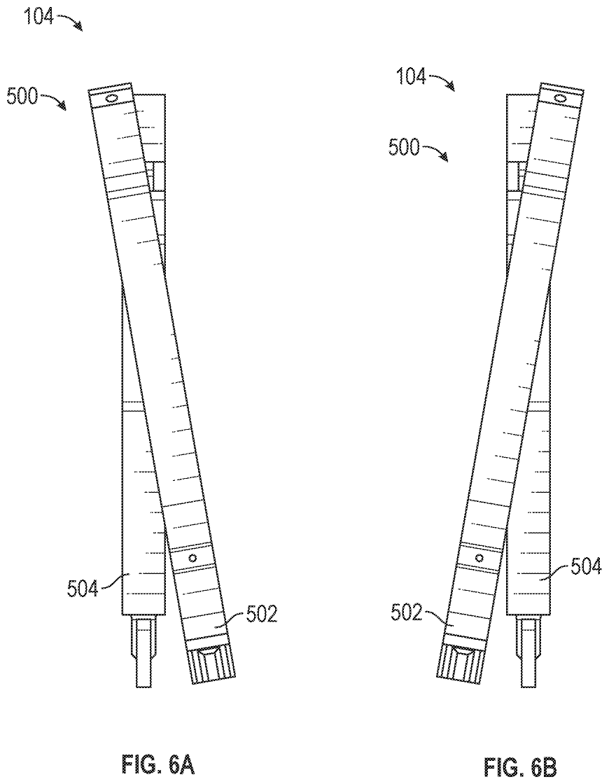

The one or more frame structures 104 may include various components as desired. FIGS. 2A-4B illustrate a spreader 201 as a frame structure 104, and FIGS. 5A-6B illustrate a seat leg 500 as a frame structure 104. Regardless of the particular type of frame structure 104, the frame structure 104 of the passenger seat 100 may be used to prevent and/or mitigate a pre-load on one or more components, such as front tubes, bolts, legs, spreaders, and the like, of the passenger seat 100 during dynamic events experienced by the passenger vehicle. In some embodiments, the dynamic events, such as turbulence, acceleration, sharp turns, etc., may include pitch dynamic events, roll dynamic events, and the like. The frame structure 104 may involve a rotational mechanism that allows partial rotation of some components of the passenger seat 100 to reduce and/or eliminate the pre-load on the passenger seat 100 compared to traditional passenger seats. Reducing and/or eliminating the pre-load on the one or more components of the passenger seat 100 may increase safety, compliance, comfort, and the like of the passenger seat 100.

Referring to FIGS. 2A-4B, the spreader 201 as the frame structure 104 generally includes a forward portion 202 and an aft portion 204. As mentioned, while the frame structure 104 is illustrated as a spreader 201, other suitable types of frame structures, such as legs, etc., may be possible.

The forward portion 202 includes a forward aperture 206 that may be configured to receive the forward base frame tube 112 of the passenger seat 100. The aft portion 204 includes an aft aperture 208 that may be configured to receive the aft base frame tube 114 of the passenger seat 100. The forward portion 202 is coupled to the aft portion 204 such that the forward portion 202 may be rotated relative to the aft portion 204. As a non-limiting example, a coupling mechanism between the forward portion 202 and the aft portion 204 may include a structural bolt 209 that rotatably couples the forward portion 202 to the aft portion 204.

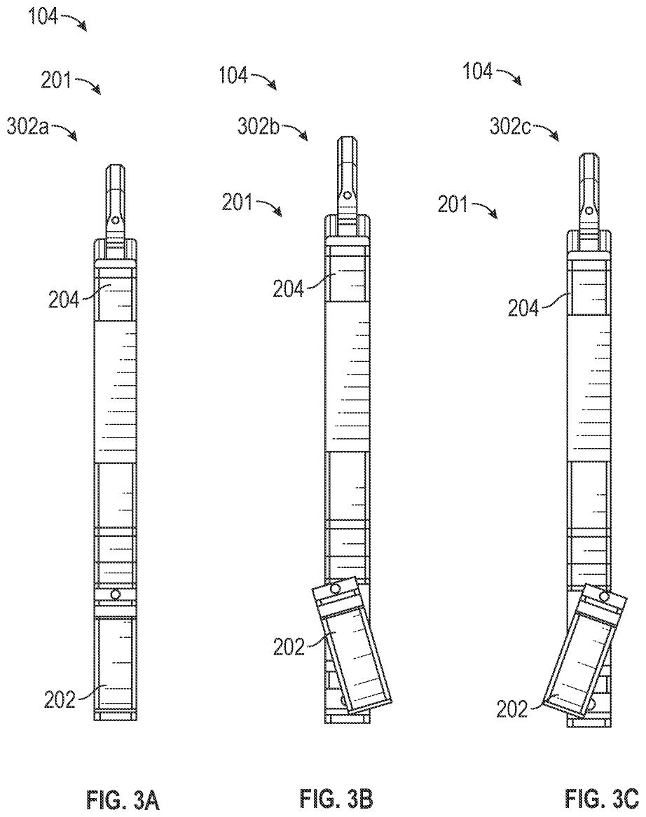

As best illustrated with respect to FIGS. 3A-C, the forward portion 202 may be rotated in a lateral direction such as with respect to the aft portion 204. For example, view 302a illustrates the forward portion 202 not rotated (e.g., in-line) with respect to the aft portion 204, view 302b illustrates the forward portion 202 rotated laterally to the left (counterclockwise) with respect to the aft portion 204, and view 302b illustrates the forward portion 202 rotated laterally right (clockwise) with respect to the aft portion 204.

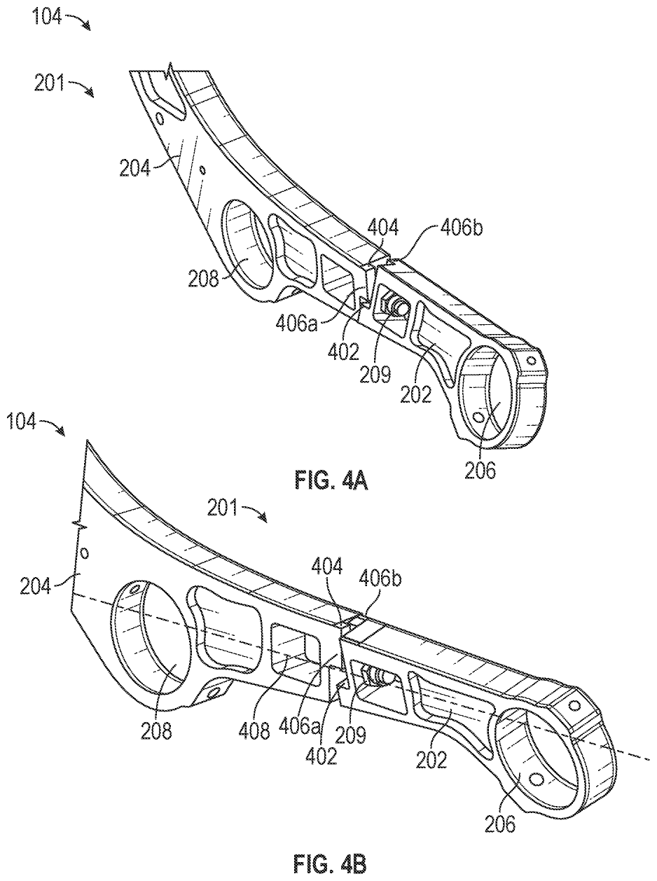

As best illustrated with respect to FIGS. 4A-B, the forward portion 202 includes an aft end 402, and the aft portion 204 includes a forward end 404. The forward end 404 may be adjacent to the aft end 402. In some embodiments, and referring to FIGS. 2A-C, at least one of the forward end 404 or the aft end 402 includes one or more stoppers 210. The stopper 210 may be positioned in the frame structure 104 to limit rotation of the forward portion 202 relative to the aft portion 204. In one non-limiting example, the forward portion 202 may rotate (e.g., less than 90 degrees) and contact the stopper 210 positioned on the aft portion 204 to prevent further rotation of the forward portion 202. In some embodiments, and referring to FIGS. 4A-B, the one or more stoppers 210 may be a first stopper 406a of a pair of stoppers 406a-b. For example, the pair of stoppers may include the first stopper 406a and a second stopper 406b. The forward portion 202 may include the first stopper 406a, and the aft portion 204 may include the second stopper 406b, or vice versa. In some embodiments, the first stopper 406a and/or the second stopper 406b may be an extension of the forward portion 202 and/or the aft portion 204, respectively, that may at least partially extend past other portions of the forward portion 202 and/or the aft portion 204, respectively. In other embodiments, other devices and/or structures may be utilized as stoppers to limit rotation of the forward portion 202 relative to the aft portion 204 as desired.

In some embodiments, and as illustrated in FIG. 4B, a rotational axis 408 of the forward portion 202 optionally intersects at least one of the forward aperture 206 or the aft aperture 208. For example, and as illustrated in FIG. 4B, the rotational axis 408 intersects the forward aperture 206 and the aft aperture 208.

FIGS. 5A-6B illustrate a seat leg 500 as the frame structure 104. Similar to the spreader 201, the seat leg 500 may include a forward portion 502 and an aft portion 504 that are rotatably coupled. In various embodiments, the forward portion 502 and the aft portion 504 may each be configured to be coupled to a floor of a passenger vehicle such as an aircraft. The forward portion 502 may be rotatably coupled to the aft portion 504 using various devices or mechanisms as desired. In one non-limiting example, one or more coupling devices 506, such as but not limited to one or more structural bolts, rotatable couples the forward portion 502 with the aft portion 504. FIG. 6A illustrates the forward portion 502 rotated left (in a counterclockwise direction), and FIG. 6B illustrates the forward portion 502 rotated right (in a clockwise direction).

In some embodiments, the forward portion 502 may include or define a forward aperture 508 that may be sized to receive the forward base frame tube 112, and the aft portion 504 may include or define an aft aperture 510 that may be sized to receive the aft base frame tube 114. Optionally, and compared to the spreader 201, a rotational axis 512 of the forward portion 502 of the seat leg 500 may not intersect the forward aperture 508 or the aft aperture 510. In some embodiments, the rotational axis 512 may intersect or otherwise be defined by the one or more coupling devices 506.

In various embodiments, the forward portion 502 and the aft portion 504 may include one or more apertures for receiving the one or more coupling devices 506. In the embodiment illustrated, a coupling portion 503 of the forward portion 502 may overlap with a corresponding coupling portion 505 of the aft portion 504, and each coupling portion 503, 505 includes an aperture for receiving the one or more coupling devices 506. Optionally, the apertures for receiving the one or more coupling devices 506 may be elongated in a lateral direction and/or optionally with a curvature (e.g., having an arc shape) in a forward and aft direction. In such embodiments, the elongated apertures with or without the curvature may further provide limits for rotation in the forward portion 502 relative to the aft portion 504.

While the coupling portions 503, 505 are illustrated in an overlapping arrangement, in other embodiments, the forward portion 502 and the aft portion 504 may have other configurations and/or engagements in the coupling region having the axis of rotation. As a non-limiting example, one of the coupling portions (e.g., coupling portion 503) may “sandwich” or overlap the other coupling portion (e.g., coupling portion 505) both above and below. In such embodiments, the coupling portion 503 may include a lower coupling portion and an upper coupling portion, and the coupling portion 505 may be received in a space defined between the upper coupling portion and the lower coupling portion of the coupling portion 503. In such embodiments, both the upper and lower coupling portions of the coupling portion 503 may define one or more apertures for the one or more coupling devices 506. In other embodiments, the coupling portion 505 may include the upper and lower coupling portions that sandwich the coupling portion 503. Other configurations of the coupling portions 503, 505 suitable for allowing rotation of the forward portion 502 relative to the aft portion 504 may be utilized as desired.

While a single coupling device 506 is illustrated in FIGS. 5A-C, in other embodiments, any number of coupling devices 506 may be utilized. As non-limiting examples, the frame structure 104 may include two coupling devices 506, three coupling devices 506, four coupling devices 506. In such embodiments, the coupling devices 506 may be arranged in various configurations, such as but not limited to alignment in a lateral direction, alignment in a forward and aft direction, in a curved or non-linear pattern, etc. In one non-limiting example, the seat leg 500 as the frame structure 104 may include two coupling devices 506 arranged in a lateral direction. In such embodiments, each of the coupling portions 503, 505 includes two apertures (optionally elongated in a lateral direction), one for each coupling device 506. In certain embodiments, increasing the number of coupling devices may provide additional support for the frame structure 104 while allowing for rotation. Additionally, or alternatively, the additional coupling devices 506 may provide rotational limits for the forward portion 502 relative to the aft portion 504.

In some embodiments, the frame structure 104 may be a first frame structure, and the seat base 102 may additionally include a second frame structure. The second frame structure may include a forward portion and an aft portion. The forward portion may include a forward aperture that may be configured to receive the forward base frame tube. The aft portion may include an aft aperture that may be configured to receive the aft base frame tube. Additionally, the forward portion of the second frame structure may be coupled to the aft portion of the second frame structure such that the forward portion of the second frame structure may be rotated relative to the aft portion of the second frame structure. In some embodiments, the first frame structure may be or include a seat leg 500, and the second frame structure may be or include a spreader 201, or vice versa.

In some embodiments, an axis of rotation of the first frame structure may be at a non-zero angle relative to an axis of rotation of the second frame structure. For example, and as best illustrated in FIGS. 4A-5C, the rotational axis 408 may be at a non-zero angle relative to the rotational axis 512. Additionally, at least one of the first frame structure or the second frame structure may include a stopper for limiting rotation of the first frame structure and/or the second frame structure, or any component or components thereof. For example, the first frame structure, the second frame structure, or a combination thereof may include the stopper 210, the pair of stoppers 406a-b, etc. In some embodiments, the forward portion of the first frame structure and the forward portion of the second frame structure may be rotated together responsive to a dynamic event. For example, and in response to a dynamic event that may involve one or more pitch forces, one or more roll forces, etc., the forward portion 202 may rotate together with the forward portion 502.

Additionally, the passenger seat 100, or any component thereof, may include various metals or metallic elements as desired, including but not limited to aluminum, an aluminum alloy, titanium, a titanium alloy, nickel, a nickel alloy, brass, a brass alloy, steel, a steel alloys, stainless steel or a stainless-steel alloy, combinations thereof, or any other suitable metal or metallic alloy. In other non-limiting examples, the passenger seat 100, or any component thereof, includes other types of metallic elements, such as titanium, zinc, and the like, or metallic alloys such as titanium alloys, zinc alloys, and the like. In some embodiments, some components (e.g., the forward portion 202, the aft portion 204, the stopper 210, etc.) may include non-metallic elements such as rubber, polymer, plastics, and the like.

In the following, further examples are described to facilitate the understanding of the invention:

Example 1. A passenger seat for an aircraft, the passenger seat comprising a seat base, the seat base comprising a frame structure comprising: a forward portion comprising a forward aperture configured to receive a forward base frame tube; and an aft portion comprising an aft aperture configured to receive an aft base frame tube, wherein the forward portion is coupled to the aft portion such that the forward portion is rotatable relative to the aft portion.

Example 2. The passenger seat of any of the preceding or subsequent examples, wherein the frame structure is a spreader.

Example 3. The passenger seat of any of the preceding or subsequent examples, wherein the frame structure is a seat leg.

Example 4. The passenger seat of any of the preceding or subsequent examples, wherein the forward portion is rotatable in a lateral direction.

Example 5. The passenger seat of any of the preceding or subsequent examples, wherein the forward portion comprises an aft end and the aft portion comprises a forward end, wherein the forward end is adjacent to the aft end, and wherein at least one of the forward end or the aft end comprises a stopper for limiting rotation of the forward portion relative to the aft portion.

Example 6. The passenger seat of any of the preceding or subsequent examples, wherein the stopper is a first stopper of a pair of stoppers, and wherein the forward end and the aft end each comprise a different stopper of the pair of stoppers.

Example 7. The passenger seat of any of the preceding or subsequent examples, wherein a structural bolt rotatably couples the forward portion to the aft portion.

Example 8. The passenger seat of any of the preceding or subsequent examples, wherein a rotational axis of the forward portion intersects at least one of the forward aperture or the aft aperture.

Example 9. The passenger seat of any of the preceding or subsequent examples, wherein a rotational axis of the forward portion does not intersect the forward aperture or the aft aperture.

Example 10. The passenger seat of any of the preceding or subsequent examples, further comprising the forward base frame tube and the aft base frame tube.

Example 11. The passenger seat of any of the preceding or subsequent examples, wherein the frame structure is a first frame structure, and wherein the seat base further comprises a second frame structure comprising: a forward portion comprising a forward aperture configured to receive the forward base frame tube; and an aft portion comprising an aft aperture configured to receive the aft base frame tube, wherein the forward portion of the second frame structure is coupled to the aft portion of the second frame structure such that the forward portion of the second frame structure is rotatable relative to the aft portion of the second frame structure.

Example 12. The passenger seat of any of the preceding or subsequent examples, wherein the first frame structure is a seat leg and the second frame structure is a spreader.

Example 13. The passenger seat of any of the preceding or subsequent examples, wherein an axis of rotation of the first frame structure is at a non-zero angle relative to an axis of rotation of the second frame structure.

Example 14. The passenger seat of any of the preceding or subsequent examples, wherein at least one of the first frame structure or the second frame structure comprises a stopper for limiting rotation.

Example 15. The passenger seat of any of the preceding or subsequent examples, wherein the forward portion of the first frame structure and the forward portion of the second frame structure are rotatable together responsive to a dynamic event.

Example 16. A spreader for a passenger seat for an aircraft, the spreader comprising: a forward portion comprising a forward aperture configured to receive a forward base frame tube; and an aft portion comprising an aft aperture configured to receive an aft base frame tube, wherein the forward portion is coupled to the aft portion such that the forward portion is rotatable relative to the aft portion.

Example 17. The spreader of any of the preceding or subsequent examples, wherein the forward portion comprises a first stopper and the aft portion comprises a second stopper, wherein the first stopper is configured to engage the second stopper to limit rotation of the forward portion relative to the aft portion.

Example 18. The spreader of any of the preceding or subsequent examples, wherein an axis of rotation of the forward portion intersects at least the forward aperture.

Example 19. A seat leg for a passenger seat for an aircraft, the seat leg comprising: a forward portion configured to be coupled to a floor of the aircraft; and an aft portion configured to be coupled to the floor of the aircraft, wherein the forward portion is coupled to the aft portion such that the forward portion is rotatable relative to the aft portion.

Example 20. The seat leg of any of the preceding or subsequent examples, wherein the forward portion further comprises a forward aperture configured to receive a forward base frame tube, and wherein the aft portion further comprises an aft aperture configured to receive an aft base frame tube.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the FIG. (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, c and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A passenger seat for an aircraft, the passenger seat comprising a seat base, the seat base comprising a frame structure comprising:
a forward portion comprising a forward aperture configured to receive a forward base frame tube; and
an aft portion comprising an aft aperture configured to receive an aft base frame tube, wherein the forward portion is coupled to the aft portion such that the forward portion is rotatable relative to the aft portion about a rotational axis extending generally in a forward-aft direction.

2. The passenger seat of claim 1, wherein the frame structure is a spreader.

3. The passenger seat of claim 1, wherein the frame structure is a seat leg.

4. The passenger seat of claim 1, wherein the forward portion is rotatable so as to cause at least a portion of the forward portion to extend outward in a lateral direction.

5. The passenger seat of claim 1, wherein the forward portion comprises an aft end and the aft portion comprises a forward end, wherein the forward end is adjacent to the aft end, and wherein at least one of the forward end or the aft end comprises a stopper for limiting rotation of the forward portion relative to the aft portion.

6. The passenger seat of claim 5, wherein the stopper is a first stopper of a pair of stoppers, and wherein the forward end and the aft end each comprise a different stopper of the pair of stoppers. cm 7. The passenger seat of claim 1, wherein a structural bolt rotatably couples the forward portion to the aft portion.

8. The passenger seat of claim 1, wherein the rotational axis of the forward portion intersects at least one of the forward aperture or the aft aperture.

9. The passenger seat of claim 1, wherein the rotational axis of the forward portion does not intersect the forward aperture or the aft aperture.

10. The passenger seat of claim 1, further comprising the forward base frame tube and the aft base frame tube.

11. The passenger seat of claim 1, wherein the frame structure is a first frame structure, and wherein the seat base further comprises a second frame structure comprising:
a forward portion comprising a forward aperture configured to receive the forward base frame tube; and
an aft portion comprising an aft aperture configured to receive the aft base frame tube, wherein the forward portion of the second frame structure is coupled to the aft portion of the second frame structure such that the forward portion of the second frame structure is rotatable relative to the aft portion of the second frame structure about a first rotational axis extending generally in a forward-aft direction.

12. The passenger seat of claim 11, wherein the first frame structure is a seat leg and the second frame structure is a spreader.

13. The passenger seat of claim 11, wherein a second rotational axis of the first frame structure extends generally in a forward-aft direction and is at a non-zero angle relative to the first rotational axis of the second frame structure.

14. The passenger seat of claim 11, wherein at least one of the first frame structure or the second frame structure comprises a stopper for limiting rotation.

15. The passenger seat of claim 11, wherein the forward portion of the first frame structure and the forward portion of the second frame structure are rotatable together responsive to a dynamic event.

16. A spreader for a passenger seat for an aircraft, the spreader comprising:
a forward portion comprising a forward aperture configured to receive a forward base frame tube; and
an aft portion comprising an aft aperture configured to receive an aft base frame tube, wherein the forward portion is coupled to the aft portion such that the forward portion is rotatable relative to the aft portion about a rotational axis extending generally in a forward-aft direction.

17. The spreader of claim 16, wherein the forward portion comprises a first stopper and the aft portion comprises a second stopper, wherein the first stopper is configured to engage the second stopper to limit rotation of the forward portion relative to the aft portion.

18. The spreader of claim 16, wherein an axis of rotation of the forward portion intersects at least the forward aperture.

19. A seat leg for a passenger seat for an aircraft, the seat leg comprising:
a forward portion configured to be coupled to a floor of the aircraft; and
an aft portion configured to be coupled to the floor of the aircraft, wherein the forward portion is coupled to the aft portion such that the forward portion is rotatable relative to the aft portion about a rotational axis extending generally in a forward-aft direction.

20. The seat leg of claim 19, wherein the forward portion further comprises a forward aperture configured to receive a forward base frame tube, and wherein the aft portion further comprises an aft aperture configured to receive an aft base frame tube.
